(19) United States
(12) Patent Application Publication
(10) Pub. No.: US 2026/0365834 A1
(43) Pub. Date: Nov. 19, 2026

(54) THREE-DIMENSIONAL LOOP MATERIALS AND USES THEREOF

(71) Applicant: Dow Global Technologies LLC, Midland, MI (US)

(72) Inventors: Zheng Zhang, Shanghai (CN); Ming Ming, Shanghai (CN); Yabin Sun, Shanghai (CN); Libo Du, Shanghai (CN); Xin Huang, Shanghai (CN); Xilun Weng, Shanghai (CN)

(21) Appl. No.: 19/103,340

(22) PCT Filed: Oct. 13, 2022
(86) PCT No.: PCT/CN2022/125072

§ 371 Date: Feb. 12, 2025

(51) Int. Cl. C08L 23/0807; C08J 3/20; C08K 5/03; D04H 3/007; D04H 3/03

(52) U.S. Cl. CPC C08L 23/0815; C08J 3/201; C08K 5/03; D04H 3/007; D04H 3/03; C08J 2323/08; C08J 2423/08; C08L 2201/02; C08L 2205/025; D10B 2321/021; D10B 2401/04; D10B 2505/08

(57) ABSTRACT

A three-dimensional loop material made from a polyolefin resin composition, having desirable cushioning and flame resistance properties for applications especially transportation industry. Also provided are methods of making the three-dimensional loop material, and products made therefrom.

### FIELD OF THE DISCLOSURE

The present disclosure relates to a three-dimensional loop material made from a polyolefin resin composition, having desirable cushioning and flame resistance properties for applications especially transportation industry, methods of making the three-dimensional loop material, and products made therefrom.

### BACKGROUND

Three-dimensional loop (3D loop) cushions are fused polymer filaments to form the random network structures. They have good resilience, open structure for high breathability and good durability as a cushion material. In addition, the thermoplastic feature of 3D loop products makes them very friendly for recycling, which is a great contribution to reduce plastic waste compared to thermoset polyurethane (PU) foams. The sustainability value has been well recognized by home use applications. As a result, the polyolefin 3D loop has been used in products like mattress, pillow, and cushion pads. This new material has also received great interest from auto market, to replace PU foams in the seat cushion for comfort and sustainability values.

In transportation field, seats are used in a compacted space, and may be used for public purpose. The flame resistance requirement is more demanding than home use applications. For example, car seats cushion should meet the standard of flammability of automotive interior materials. But from both material and structure points of view, neat polyolefin 3D loops can hardly achieve such high flame resistance. As a result, incumbent polyolefin 3D loop materials are not able to apply in auto seat industry.

Polyolefins are known as easy-to-burn materials for their hydrocarbon chemistry. Polyolefin used in 3D loop application requires high melt flow for fiber extrusion, which means when a large amount of commodity flame retardant added to achieve enough flame resistance, it will increase the melt viscosity to influence 3D loop fiber extrusion, and the mechanical properties of cushion will be impacted as well. 3D loops are made from very fine fibers with large open structures, and as a result, it provides high surface area and easy air flow to support burning.

Thus, there is unfulfilled need in the transportation industry for highly efficient flame-resistant polyolefin formulations for making 3D loop materials that provides balance between flame resistance and mechanical properties.

### SUMMARY OF THE DISCLOSURE

In an aspect, the present disclosure provides a three-dimensional loop material comprising a polyolefin resin composition, wherein the composition comprises:
(a) from 95% to 98% by weight of the composition of at least one ethylene/alpha-olefin copolymer, and
(b) from 2% to 5% by weight of the composition of at least one flame retardant.

In a further aspect, the present disclosure provides a method for producing the three-dimensional loop material disclosed herein, comprising the steps of:
(i) melting a polyolefin resin composition comprising:
   (a) from 95% to 98% by weight of the composition of at least one ethylene/alpha-olefin copolymer, and
   (b) from 2% to 5% by weight of the composition of at least one flame retardant;
(ii) discharging the molten polyolefin resin composition to a downward direction from a nozzle with a plurality of orifices to obtain loops of continuous fibers in a molten state;
(iii) allowing respective loops to come into contact with one another and to be heat-bonded whereby to form a random loop structure; and
(iv) cooling the structure.

In a further aspect, the present disclosure provides use of the three-dimensional loop material as a cushioning material.

In a further aspect, the present disclosure provides a product comprising the three-dimensional loop material disclosed herein.

It is to be understood that both the foregoing general description and the following detailed description are exemplary and explanatory only and are not restrictive of the invention, as claimed.

### DETAILED DESCRIPTION OF THE DISCLOSURE

Unless defined otherwise, all technical and scientific terms used herein have the same meaning as commonly understood by one of ordinary skill in the art to which the invention belongs. Also, all publications, patent applications, patents, and other references mentioned herein are incorporated by reference.

### I. DEFINITIONS

All percentages mentioned herein are by weight, and temperatures in °C, unless stated to the contrary, implicit from the context, or customary in the art.

The term “and/or” means “and, or as an alternative”. All ranges include endpoints unless otherwise indicated.

The terms “comprising,” “including,” “having,” and their derivatives, as used herein, are not intended to exclude the presence of any additional component, step or procedure, whether or not the same is specifically disclosed. In order to avoid any doubt, all compositions claimed through use of the term “comprising” may include any additional additive, adjuvant, or compound, whether polymeric or otherwise, unless stated to the contrary. In contrast, the term, “consisting essentially of” excludes from the scope of any succeeding recitation any other component, step or procedure, excepting those that are not essential to operability. The term “consisting of” excludes any component, step or procedure not specifically delineated or listed.

A “composition” or “formulation” is a mixture or blend of two or more components. In the context of a mix or blend of materials from which an article of manufacture is fabricated, the composition includes all the components of the mix, e.g., polymers, flame retardants, and any other additives or agents such as antioxidants, pigments, etc.

A “polymer” is a polymeric compound prepared by polymerizing monomers, whether of the same or a different type. The generic term “polymer” thus embraces the term homopolymer, usually employed to refer to polymers prepared from only one type of monomer, and the term interpolymer.

An “interpolymer” is a polymer prepared by the polymerization of two or more different types of monomers. This generic term includes copolymers, usually employed to refer to polymers prepared from two different types of monomers, and polymers prepared from more than two different types of monomers, e.g., terpolymers, tetrapolymers, etc.

An “alpha-olefin” or “α-olefin” generally is a C₃₋₂₀ linear, branched or cyclic hydrocarbon molecule comprising an ethylenic unsaturation between the first and second carbon atoms.

A “polyolefin” or “PO” is a polymer that contains more than 50 mole percent polymerized olefin monomer (based on total amount of polymerizable monomers), and optionally, may contain one or more comonomer(s). Nonlimiting examples of olefin-based polymer include ethylene-based polymer and propylene-based polymer.

An “ethylene-based polymer” is a polymer that contains more than 50 mole percent polymerized ethylene monomer (based on the total amount of polymerizable monomers) and, optionally, may contain one comonomer.

A “propylene-based polymer” is a polymer that contains more than 50 mole percent polymerized propylene monomer (based on the total amount of polymerizable monomers) and, optionally, may contain one comonomer.

An “ethylene/alpha-olefin interpolymer” is an interpolymer that comprises a majority amount (i.e., over 50 mole percent) polymerized ethylene monomer (based on the total amount of polymerizable monomers) and one or more alpha-olefin comonomers.

The term “flame retardant” is used herein to indicate a flame retardant which can be any halogen-containing compound or mixture of compounds which imparts flame resistance to the compositions or material of the present disclosure.

The term “flame retardant synergist” is used herein to indicate inorganic or organic compounds which enhance the effectiveness of flame-retardants, especially halogenated flame retardants.

### II. THREE-DIMENSIONAL LOOP MATERIAL

The present disclosure provides a three-dimensional loop material which comprises fibers of random looped structures.

In some embodiments, the random looped fibers are bonded with one another, wherein the loops are randomly formed by allowing continuous fibers to bend to come in contact with one another in a molten state and be heat-bonded at a plurality of contact points.

The vast majority of the fibers comprised in the three-dimensional loop material are made from the polyolefin resin composition of the present disclosure, which are also referred to herein as “polymer fibers”. In some embodiments, based on the total weight of the fibers comprised in the three-dimensional loop material, more than 90%, more than 95%, more than 98%, more than 99%, more than 99.5% or more than 99.9% of the fibers are made from the polyolefin resin composition of the present disclosure.

In some embodiments, based on the total weight of the fibers comprised in the three-dimensional loop material, less than 10%, less than 5%, less than 2%, less than 1%, less than 0.5% or less than 0.1% of the fibers are made from other materials, for example, aramid fibers, polyester fibers, cellulose fibers (e.g., regenerated cellulose fibers). In some embodiments, based on the total weight of the fibers comprised in the three-dimensional loop material, less than 10%, less than 5%, less than 2%, less than 1%, less than 0.5% or less than 0.1% of the fibers are made from a propylene-based polymer. In some embodiments, the propylene-based polymer does not include PBE.

In some embodiments, the fibers comprised in the three-dimensional loop material have a diameter that is no less than about 0.3 mm. In some embodiments, the fibers comprised in the three-dimensional loop material have a diameter that is no more than about 2.0 mm. In some embodiments, the fibers comprised in the three-dimensional loop material have a diameter that is within the range formed by taking any two of the numerical values in the following list as the endpoints: 0.3, 0.4, 0.5, 0.6, 0.8, 1.0, 1.2, 1.4, 1.6, 1.8, 1.9, and 2.0 mm. In some embodiments, the fibers comprised in the three-dimensional loop material have a diameter that is within the range from about 0.3 mm to about 2.0 mm, from about 0.5 mm to about 2.0 mm, from about 0.3 mm to about 1.8 mm, or from about 0.5 mm to about 1.8 mm.

In some embodiments, the three-dimensional loop material has a density that is no less than about 30 kg/m³. In some embodiments, the three-dimensional loop material has a density that is no more than about 100 kg/m³. In some embodiments, the three-dimensional loop material has a density that is within the range formed by taking any two of the numerical values in the following list as the endpoints: 30, 40, 50, 60, 70, 80, 90 and 100 kg/m³. In some embodiments, the three-dimensional loop material has a density that is within the range from about 30 kg/m³ to about 100 kg/m³, from about 50 kg/m³ to about 100 kg/m³, from about 30 kg/m³ to about 80 kg/m³, or from about 50 kg/m³ to about 100 kg/m³.

In some embodiments, the three-dimensional loop material is a nonwoven material.

In some embodiments, the horizontal burning speed of the three-dimensional loop material is less than 20 mm/min.

In some embodiments, flexural modulus of the polymers (e.g., polymer fibers) comprised in the three-dimensional loop material is less than 70 MPa, as measured in accordance with ASTM D790.

In some embodiments, the three-dimensional loop material is measured to have a rebound value of at least 45%, at least 48%, or at least 50%, as measured in accordance with ASTM D3574-17.

### III. POLYOLEFIN RESIN COMPOSITION

The three-dimensional loop material comprises a polyolefin resin composition comprising: (a) at least one ethylene/alpha-olefin copolymer, and, (b) at least one flame retardant.

In some embodiments, the at least one ethylene/alpha-olefin copolymer and the at least one flame retardant are mixed or blended together in the polyolefin resin composition, rather than in different layers of a laminate (for example with one coated on the other).

The polyolefin resin composition comprises at least 95%, at least 95.5%, at least 96%, at least 96.2% or at least 96.5% by weight of the composition of at least one ethylene/alpha-olefin copolymer. In some embodiments, the polyolefin resin composition comprises at most 98%, at most 97.5% or at most 97% by weight of the composition of at least one ethylene/alpha-olefin copolymer. In some embodiments, the polyolefin resin composition comprises from 95% to 98%, from 95.5% to 98%, from 96% to 98%, from 96.2% to 98% or from 96.5% to 98% by weight of the composition of at least one ethylene/alpha-olefin copolymer.

The polyolefin resin composition comprises at most 5%, at most 4.5%, at most 4%, at most 3.8% or at most 3.5% by weight of the composition of at least one flame retardant. In some embodiments, the polyolefin resin composition comprises at least 2%, at least 2.5%, at least 3% or at least 3.3% by weight of the composition of at least one flame retardant. In some embodiments, the polyolefin resin composition comprises from 2% to 5%, from 2% to 4.5%, from 2% to 4%, from 2% to 3.8% or from 2% to 3.5% by weight of the composition of at least one flame retardant.

In some embodiments, the polyolefin resin composition can comprise polyolefin resins selected from the group consisting of polyethylene (PE) polymers, polyolefin elastomers (POE), olefin block copolymers (OBC), propylene-based elastomers (PBE), and any combination thereof. Exemplary PBEs include those commercially available from The Dow Chemical Company, under the trade name VERSIFY™, or from ExxonMobil Chemical Company, under the trade name VISTAMAXX™.

A “propylene-based elastomer” (or “PBE”) comprises at least one copolymer with at least 50 weight percent of units derived from propylene and at least about 5 weight percent of units derived from a comonomer other than propylene, such as ethylene for example.

In some embodiments, the polyolefin resins comprised in the polyolefin resin composition have a melting index (MI) in a range of from 2 to 20 g/10 min @190 C, 2.16 kg, for example, from 5 to 20, from 8 to 15 or from 10 to 15 g/10 min @190 C, 2.16 kg, as measured in accordance with ASTM D1238.

In some embodiments, the polyolefin resins comprised in the polyolefin resin composition have a melting peak temperature (Tm) of lower than 121 °C.

In some embodiments, the polyolefin resin composition can further comprise one or more additives or agents such as antioxidants, pigments, and the like.

### IV. ETHYLENE/ALPHA-OLEFIN COPOLYMER

The polyolefin resin composition comprises at least one ethylene/alpha-olefin copolymer. In some embodiments, the ethylene/alpha-olefin copolymer is a random ethylene/alpha-olefin interpolymer or a block ethylene/alpha-olefin interpolymer.

The ethylene/alpha-olefin copolymer comprises ethylene as a major monomer. In some embodiments, the ethylene/alpha-olefin copolymer comprises at least 60%, for example, at least 65%, at least 70%, at least 75% or at least 80% by weight of the copolymer of ethylene as the major monomer. In some embodiments, the amount of ethylene comprised in the ethylene/alpha-olefin copolymer is within the range formed by taking any two of the numerical values in the following list as the endpoints: 60%, 65%, 70%, 75%, 80%, 85% and 90%, by weight of the copolymer. In some embodiments, the ethylene/alpha-olefin copolymer comprises from 60% to 90%, from 65% to 90%, from 70% to 90% or from 75% to 90% by weight of the copolymer of ethylene.

The ethylene/alpha-olefin copolymer comprises at least one alpha-olefin as a comonomer. Typically, the at least one alpha-olefin comprised in the ethylene/alpha-olefin copolymer of the present disclosure has four or more carbon atoms. In some embodiments, the ethylene/alpha-olefin copolymer comprises one or more C₄₋₁₀ alpha-olefins as comonomers. In some exemplary embodiments, the C₄₋₁₀ alpha-olefin can be selected from the group consisting of 1-butene, 1-pentene, 1-hexene, 1-heptene, 1-octene, 1-nonene, 1-decene, and combinations thereof. In some embodiments, the C₄₋₁₀ alpha-olefin comprises 1-octene. In some exemplary embodiments, the ethylene/alpha-olefin copolymer can be selected from the group consisting of ethylene/1-hexene copolymer, ethylene/1-heptene copolymer, ethylene/1-octene copolymer, ethylene/1-nonene copolymer, ethylene/1-decene copolymer, and combinations thereof. In some embodiments, the ethylene/alpha-olefin copolymer comprises ethylene/1-octene copolymer.

In some embodiments, the ethylene/alpha-olefin copolymer comprises at most 40%, for example, at most 35%, at most 30%, at most 25%, at most 20%, at most 15% or at most 10% by weight of the copolymer of a C₄₋₁₀ alpha-olefin as comonomer. In some embodiments, the amount of the C₄₋₁₀ alpha-olefin comprised in the ethylene/alpha-olefin copolymer is within the range formed by taking any two of the numerical values in the following list as the endpoints: 40%, 35%, 30%, 25%, 20%, 15%, and 10%, by weight of the copolymer. In some embodiments, the ethylene/alpha-olefin copolymer comprises from 40% to 10%, from 35% to 10%, from 30% to 10% or from 25% to 10% by weight of the copolymer of a C₄₋₁₀ alpha-olefin.

Examples of the ethylene/alpha-olefin copolymers suitable for use in the polyolefin resin composition of the present disclosure include those marketed by The Dow Chemical Company under the trade name ENGAGE™.

### V. FLAME RETARDANT

At least one flame retardant is comprised in the polyolefin resin composition to make it capable of extinguishing flames or at least slowing the spread of fire in the material and find suitable use in transportation industry.

In some embodiments, the polyolefin resin composition comprises at least one flame retardant that is selected from halogenated flame retardants. In some embodiments, the polyolefin resin composition comprises at least one flame retardant that is selected from brominated flame retardants and chlorinated flame retardants.

In some specific embodiments, the polyolefin resin composition comprises at least one flame retardant that is selected from brominated flame retardants, for example, those having the bromine bonded to unsaturated or aromatic carbons (also referred to as “aromatic bromine compounds”). In some embodiments, the brominated flame retardant is selected from the group consisting of bis(2-hydroxyethyl)ether of tetrabromobisphenol A, bis(3-acryloyloxy-2-hydroxypropyl)ether of tetrabromobisphenol A, bis(3-methacryloyloxy-2-hydroxypropyl)ether of tetrabromobisphenol A, bis(3-hydroxypropyl)ether of tetrabromobisphenol A, bis(2,3-dibromopropyl)ether of tetrabromobisphenol A, diallyl ether of tetrabromobisphenol A, and bis(vinylbenzyl)ether of tetrabromobisphenol A; brominated polycarbonates, tetrabromobisphenol A polycarbonate oligomer, brominated polyacrylate such as polypentabromobenzyl acrylate; brominated polystyrenes, such as polydibromostyrenes and polytribromostyrenes; brominated BPA polyepoxides, tetrabromocyclooctanes; dibromoethyldibromocyclohexanes such as 1,2-dibromo-4-(1,2-dibromoethyl)-cyclohexane; ethylene-bis-tetrabromophthalimide; hexabromocyclododecanes; tetrabromophthalic anhydrides; brominated diphenylethers such as decabromodiphenyl ether; poly(2,6-dibromophenylene ether); tris(2,4,6-tribromophenoxy-1,3,5-triazine; tris(tribromoneopentyl)phosphate; decabromodiphenyl ethane; and any combination thereof. Non-limiting examples of suitable flame retardants can include 1,2-bis(2,3,4,5,6-pentabromophenyl) ethane (CAS #84852-53-9) and polypentabromobenzyl acrylate (CAS #59447-57-3).

Optionally, other known flame retardants such as metal hydroxides can be additionally comprised in the polyolefin resin composition.

In some embodiments, the polyolefin resin composition can further comprise a flame retardant synergist to enhance the effectiveness of flame retardants. The flame retardant synergist includes inorganic and organic flame retardant synergists. Examples of inorganic flame retardant synergists include, but are not limited to, metal oxides, e.g. iron oxide, tin oxide, zinc oxide, aluminum oxide, alumina, antimony oxide and antimony oxide, bismuth oxide, molybdenum trioxide, and tungsten trioxide, boron compounds such as zinc borate, zinc stannate, zinc hydroxystannate, ferrocene and mixtures thereof. Examples of organic flame retardant synergists include, but are not limited to organic peroxides, such as dicumyl peroxide and polycumyl peroxide. Non-limiting examples of flame retardant synergist include antimony oxide (CAS #1309-64-4).

In some embodiments, the polyolefin resin composition comprises from 0.3% to 3%, from 0.5% to 2.5%, from 0.5% to 2%, from 0.5% to 1.5%, or from 0.7 to 1.2% by weight of the composition of a flame retardant synergist.

In some embodiments, the halogenated flame retardants and the flame retardant synergists are comprised in the polyolefin resin composition at a weight ratio of from 0.25:1 to 15:1, for example, at a weight ratio in the range formed by taking any two of the numerical values in the following list as the endpoints: 0.5:1, 0.8:1, 1:1, 1.5:1, 1.8:1, 2:1, 2.5:1, 3:1, 3.5:1, 4:1, 4.5:1, 5:1, 6:1, 7:1, 8:1, 9:1, 10:1, 11:1, 12:1, 13:1, 14:1 and 15:1. In some embodiments, the halogenated flame retardants and the flame retardant synergists are comprised in the polyolefin resin composition at a weight ratio of from 0.25:1 to 10:1, from 0.5:1 to 5:1, from 1:1 to 5:1, from 2:1 to 4:1, or around 3:1.

In some embodiments, the total loading amount of the flame retardant and the flame retardant synergist in the polyolefin resin composition or in the three-dimensional loop material is no more than 5% by weight of the material, for example, no more than 4.5%, 4%, 3.5%, or 3% by weight of the material.

### VI. PRODUCTION OF THREE-DIMENSIONAL LOOP MATERIAL

The present disclosure also provides a method for producing the three-dimensional loop material disclosed herein, comprising the steps of:
(i) melting a polyolefin resin composition comprising:
   (a) from 95% to 98% by weight of the composition of at least one ethylene/alpha-olefin copolymer, and
   (b) from 2% to 5% by weight of the composition of at least one flame retardant;
(ii) discharging the molten polyolefin resin composition to a downward direction from a nozzle with a plurality of orifices to obtain loops of continuous fibers in a molten state;
(iii) allowing respective loops to come into contact with one another and to be heat-bonded whereby to form a random loop structure; and
(iv) cooling the structure.

In some embodiments, the melting is carried out at a temperature ranged from 170 °C to 220 °C, for example, from 170 °C to 210 °C, from 180 °C to 210 °C, or from 180 °C to 200 °C. In some embodiments, the cooling is carried out at a temperature ranged from 25 °C to 40 °C, for example, from 30 °C to 40 °C, or from 30 °C to 35 °C.

In some embodiments, the steps (iii) and (iv) can be carried out simultaneously, for example, in a cold water bath.

The polyolefin resin composition is as described in the “III. Polyolefin resin composition” portion above and is not repeatedly described here for brevity.

In some embodiments, the method further comprises a step of drying the formed three-dimensional loop material before use or storage.

### VII. USE OF THREE-DIMENSIONAL LOOP MATERIAL

The present disclosure also provides use of the three-dimensional loop material as a cushioning material.

The three-dimensional loop material can be adapted for a variety of uses. Examples include, but are not limited to, use of the three-dimensional loop material with chairs, stools, home furniture, beds, sofas, mattress, pillows, automobiles, motorcycles, trains, airplanes, boats, ships, seacraft, aircraft, spacecraft, tractors, bicycles, unicycles, tricycles, recreational vehicles, dune buggies, jet skis, stadium seats, spacecraft, hovercraft, ski lifts, roller coaster, glider, luge, bobsled, recliners, gurneys, beds, yoga mats, pet crate liners, gardening knee mats, or any other kind of cycle, vehicle, seat, or furniture. In some embodiments, the three-dimensional loop material is used in the seats of automobiles, motorcycles, trains, airplanes, boats, seacraft, aircraft, spacecraft and so on. In some embodiments, the three-dimensional loop material is used in chairs, stools, home furniture, beds, sofas, mattress, pillows and so on.

When the three-dimensional loop material provided herein is used as a cushioning material, the specific polymers to be used, fineness, fiber diameter and bulk density should be selected depending on the purpose of use and where it is to be used.

In some embodiments, the three-dimensional loop material provided herein can be used upon forming the structure into a suitable shape with the use of a mold etc. to the degree the three-dimensional loop material is not impaired, and covering same with an outerwrap.

The present disclosure further provides a product (e.g., a cushioning material or a cushion) comprising the three-dimensional loop material disclosed herein.

It is to be understood that both the foregoing general description and the following detailed description are exemplary and explanatory only and are not restrictive of the invention, as claimed.

### EXAMPLES

Some embodiments of the invention will now be described in the following Examples, wherein all parts and percentages are by weight unless otherwise specified.

### A. Materials/Ingredients

TABLE 1
Raw materials

| | | Chemical Description, Chemical | |
|---|---|---|---|
| Ingredient Type | Product Name | formula, or Structure | Source |
| Polymer resin | ENGAGE ™ 8402 | Copolymer of ethylene and octene | The Dow Chemical |
| | | | Company |
| Polymer resin | ENGAGE ™ 8450 | Copolymer of ethylene and octene | The Dow Chemical |
| | | | Company |
| Flame retardant | ADK STAB | Piperazine pyrophosphate and | ADEKA |
| | FP-2500s | Phosphoric acid compound | |
| Flame retardant | FR-1410 | 1,2-Bis(2,3,4,5,6-pentabromophenyl)ethane | ICL |
| Flame retardant | FR-370 | 2,2-Bis-(bromomethyl)-3-bromo-1- | ICL |
| | | propanol phosphate | |
| Flame retardant | FR-1025 | Poly-pentabromobenzyl acrylate | ICL |
| Flame retardant | SR-800 | Tetrabromobisphenol A bis (2, | Sunris |
| | | 3-dibromopropyl ether) | |
| Synergistic agent | antimony oxide | Sb₂O₃ | Huaxing |

TABLE 2
Neat POE and halogen-free (FP-2500s)
formulations as comparative samples

| Ingredient Type | SI Units | CE1 | CE2 | CE3 |
|---|---|---|---|---|
| ENGAGE 8402 | wt % | 60 | 48 | 45 |
| ENGAGE 8450 | wt % | 40 | 32 | 30 |
| ADK STAB FP-2500s | wt % | 0 | 20 | 25 |

Calculation

| | | | | |
|---|---|---|---|---|
| polyolefin content | wt % | 100 | 80 | 75 |
| additive content | wt % | 0 | 20 | 25 |

TABLE 3
Halogen flame retardant (FR-1410) modified formulations

| Ingredient Type | SI Units | IE1 | IE2 | IE3 | CE4 | CE5 | CE6 | CE7 | CE8 |
|---|---|---|---|---|---|---|---|---|---|
| ENGAGE 8402 | wt % | 58.4 | 57.6 | 57 | 56 | 54.4 | 52 | 49.6 | 47.2 |
| ENGAGE 8450 | wt % | 38.9 | 38.4 | 38 | 37.3 | 36.3 | 34.6 | 33.1 | 31.5 |
| FR-1410 | wt % | 2 | 3 | 3.8 | 5 | 7 | 10 | 13 | 16 |
| antimony oxide | wt % | 0.7 | 1 | 1.2 | 1.7 | 2.3 | 3.4 | 4.3 | 5.3 |

Calculation

| | | | | | | | | | |
|---|---|---|---|---|---|---|---|---|---|
| polyolefin content | wt % | 97.3 | 96 | 95 | 93.3 | 90.7 | 86.6 | 82.7 | 78.7 |
| additive content | wt % | 2.7 | 4 | 5 | 6.7 | 9.3 | 13.4 | 17.3 | 21.3 |

TABLE 4
Halogen flame retardant (FR-370) modified formulations

| Ingredient Type | SI Units | CE9 | CE10 | CE11 | CE12 | CE13 | CE14 | CE15 | CE16 |
|---|---|---|---|---|---|---|---|---|---|
| ENGAGE 8402 | wt % | 58.4 | 57.6 | 57 | 56 | 54.4 | 52 | 49.6 | 47.2 |
| ENGAGE 8450 | wt % | 38.9 | 38.4 | 38 | 37.3 | 36.3 | 34.6 | 33.1 | 31.5 |
| FR-370 | wt % | 2 | 3 | 3.8 | 5 | 7 | 10 | 13 | 16 |
| antimony oxide | wt % | 0.7 | 1 | 1.2 | 1.7 | 2.3 | 3.4 | 4.3 | 5.3 |

Calculation

| | | | | | | | | | |
|---|---|---|---|---|---|---|---|---|---|
| polyolefin content | wt % | 97.3 | 96 | 95 | 93.3 | 90.7 | 86.6 | 82.7 | 78.7 |
| additive content | wt % | 2.7 | 4 | 5 | 6.7 | 9.3 | 13.4 | 17.3 | 21.3 |

TABLE 5
Halogen flame retardant (FR-1025) modified formulations

| Ingredient Type | SI Units | CE17 | CE18 | IE4 | CE19 | CE20 | CE21 | CE22 | CE23 |
|---|---|---|---|---|---|---|---|---|---|
| ENGAGE 8402 | wt % | 58.4 | 57.6 | 57 | 56 | 54.4 | 52 | 49.6 | 47.2 |
| ENGAGE 8450 | wt % | 38.9 | 38.4 | 38 | 37.3 | 36.3 | 34.6 | 33.1 | 31.5 |
| FR-1025 | wt % | 2 | 3 | 3.8 | 5 | 7 | 10 | 13 | 16 |
| antimony oxide | wt % | 0.7 | 1 | 1.2 | 1.7 | 2.3 | 3.4 | 4.3 | 5.3 |

Calculation

| | | | | | | | | | |
|---|---|---|---|---|---|---|---|---|---|
| polyolefin content | wt % | 97.3 | 96 | 95 | 93.3 | 90.7 | 86.6 | 82.7 | 78.7 |
| additive content | wt % | 2.7 | 4 | 5 | 6.7 | 9.3 | 13.4 | 17.3 | 21.3 |

TABLE 6
Halogen flame retardant (SR-800) modified formulations

| Ingredient Type | SI Units | CE24 | CE25 | CE26 | CE27 | CE28 | CE29 | CE30 | CE31 |
|---|---|---|---|---|---|---|---|---|---|
| ENGAGE 8402 | wt % | 58.4 | 57.6 | 57 | 56 | 54.4 | 52 | 49.6 | 47.2 |
| ENGAGE 8450 | wt % | 38.9 | 38.4 | 38 | 37.3 | 36.3 | 34.6 | 33.1 | 31.5 |
| SR-800 | wt % | 2 | 3 | 3.8 | 5 | 7 | 10 | 13 | 16 |
| antimony oxide | wt % | 0.7 | 1 | 1.2 | 1.7 | 2.3 | 3.4 | 4.3 | 5.3 |

Calculation

| | | | | | | | | | |
|---|---|---|---|---|---|---|---|---|---|
| polyolefin content | wt % | 97.3 | 96 | 95 | 93.3 | 90.7 | 86.6 | 82.7 | 78.7 |
| additive content | wt % | 2.7 | 4 | 5 | 6.7 | 9.3 | 13.4 | 17.3 | 21.3 |

### B. Experimental Procedures

### Compounding:

All polymer formulations were compounded in Shanghai Dow Center by Twin Screw Extruder ZSK18 with 18 mm diameter and L/D 40. The profile temperature was set at 70-140 °C, with 500 RPM and 10 kg/h output during the compounding.

### Injection Molding:

Injection molding was conducted in Shanghai Dow Center by Fanuc S-2000I B series injection molder with 28 mm diameter. The profile temperature was set at 180 °C and mold temperature was set at 30 °C. Samples for ASTM, ISO test were all prepared by injection molding.

### 3D Loop Manufacturing:

The lab scale 3D Loop samples were collected from 3D loop mini-extrusion line in Shanghai Dow Center, The polymer compound resin pellets were fed in the single screw extruder and melt was then extruded though the T-die with 7×5 holes array, the extruder and die temperature was set at 200 °C, fiber melt dropped to cold water (30 °C) and fiber curling and bonding with each other and cooled to form 3D loop samples, the 3D loop formation speed was controlled by a pulling system equipped with the cooling tank. After extrusion all samples were dried in 80 °C oven for 12 hours before burning test.

The large 3D loop samples were prepared by Dow vendor (Zhangjiagang City DIDA machinery Co. Ltd.) under the service agreement, using POE resin compounds provided by Dow. The polymer compound resin pellets were fed in the single screw extruder and melt was then extruded though the T-die with 80×7 holes array, the extruder and die temperature was set at 200 °C, fiber melt dropped to cold water (30 °C) and fiber curling and bonding with each other and cooled to form 3D loop samples. The sample thickness was controlled at 50 mm, samples were stabilized at room temperature for 7 days and then cut into 400×400×50 mm for drop ball rebound test.

### C. Property Tests

TABLE 7
Test result of 3D loop made of neat POE
and Halogen-free (FP-2500s) modified POE

| Testing items | SI Units | CE1 | CE2 | CE3 |
|---|---|---|---|---|
| Melt index | g/10 min | 11.6 | 6.6 | 5.9 |
| Flexural modulus | MPa | 64 | 99 | 108 |
| Hardness | Shore D | 40 | 45 | 46 |
| Horizontal burning | mm/min | 420 | 263 | 157 |
| speed (3D Loop) | | | | |
| Rebound (3D Loop) | % | 54 | 30 | 20 |

TABLE 8
test result of 3D loop made of halogen flame retardant (FR-1410) modified POE

| Testing items | SI Units | IE1 | IE2 | IE3 | CE4 | CE5 | CE6 | CE7 | CE8 |
|---|---|---|---|---|---|---|---|---|---|
| Melt index | g/10 min | 11.6 | 11.4 | 11.4 | 11.0 | 10.2 | 9.9 | 10.0 | 10.5 |
| Flexural modulus | MPa | 65 | 66 | 68 | 70 | 74 | 78 | 81 | 85 |
| Hardness | Shore D | 41 | 42 | 43 | 43 | 43 | 43 | 43 | 43 |
| Horizontal burning | mm/min | 0 | 0 | 0 | 0 | 0 | 0 | 0 | 0 |
| speed (3D Loop) | | | | | | | | | |
| Rebound (3D Loop) | % | 54 | 53 | 52 | 50 | — | — | — | — |

TABLE 9
Test result of 3D loop made of halogen flame retardant (FR-370) modified POE

| Testing items | SI Units | CE9 | CE10 | CE11 | CE12 | CE13 | CE14 | CE15 | CE16 |
|---|---|---|---|---|---|---|---|---|---|
| Melt index | g/10 min | 11.8 | 12.1 | 12.2 | 12.4 | 12.4 | 13.9 | 16.2 | 16.8 |
| Flexural modulus | MPa | 65 | 66 | 66 | 71 | 71 | 72 | 76 | 77 |
| Hardness | Shore D | 40 | 41 | 43 | 44 | 45 | 46 | 46 | 46 |
| Horizontal burning | mm/min | 63 | 41 | 25 | 0 | 0 | 0 | 0 | 0 |
| speed (3D Loop) | | | | | | | | | |
| Rebound (3D Loop) | % | — | — | — | 49 | — | — | — | — |

TABLE 10
Test result of 3D loop made of halogen flame retardant (FR-1025) modified POE

| Testing items | SI Units | CE17 | CE18 | IE4 | CE19 | CE20 | CE21 | CE22 | CE23 |
|---|---|---|---|---|---|---|---|---|---|
| Melt index | g/10 min | 11 | 10.9 | 10.6 | 10.3 | 10 | 9.5 | 8.7 | 8.3 |
| Flexural modulus | MPa | 65 | 66 | 69 | 72 | 76 | 81 | 91 | 97 |
| Hardness | Shore D | 41 | 43 | 43 | 43 | 43 | 43 | 44 | 44 |
| Horizontal burning | mm/min | 76 | 57 | 0 | 0 | 0 | 0 | 0 | 0 |
| speed (3D Loop) | | | | | | | | | |
| Rebound (3D Loop) | % | — | — | — | 47 | — | — | — | — |

TABLE 12
Test result of 3D loop made of halogen flame retardant (SR-800) modified POE

| Testing items | SI Units | CE24 | CE25 | CE26 | CE27 | CE28 | CE29 | CE30 | CE31 |
|---|---|---|---|---|---|---|---|---|---|
| Melt index | g/10 min | 11.7 | 11.9 | 12 | 12.2 | 12.1 | 13.3 | 14.8 | 15.0 |
| Flexural modulus | MPa | 64 | 66 | 68 | 73 | 76 | 76 | 76 | 80 |
| Hardness | Shore D | 40 | 41 | 43 | 43 | 43 | 43 | 43 | 45 |
| Horizontal burning | mm/min | 58 | 57 | 28 | 0 | 0 | 0 | 0 | 0 |
| speed (3D Loop) | | | | | | | | | |
| Rebound (3D Loop) | % | 52 | 51 | 50 | 48 | — | — | — | — |

### D. Analysis and Discussion

A good flame resistance solution is not only to control the burning behavior of material, but also to meet the other requirements for the application, such as processability of compounds, mechanical properties of the final articles. So, in our initial trials on comparative samples such as CE2 and CE3, when 20 and 25% of intumescent halogen-free flame retardants was added to the POE, a significant hardness increase and rebound decrease was found from the modified material and 3D loop cushion, but horizontal burning speed was >100 mm/min, still out of the scope for automobile applications.

It has been found that halogenated flame retardants together with synergist additive showed higher efficiency to control the burning speed, it can reduce the overall additive loading in polymer to control the impact on the other properties and achieve relatively good flame resistance. However, not every type of halogenated flame retardant showed the same performance, the halogen content in the flame retardants, the hardness of additives, its compatibility to polyolefins, the particle size of additives, distribution of additives after compounding and many other factors will influence the final performance of both flame resistance and mechanical properties.

For example, Melt Index (MI) of the polymer compound, some flame retardants with melting points below 190 C, and they are small molecules, so the more additive used, the higher MI of the polymer compound will be, but for some polymer type of flame retardants with a melting point higher than processing temperature (>200 C), the more additive used, the lower MI it will be. To keep the processing window for 3D loop fiber extrusion, MI of the compound should between 2-20 g/10 min @ 190 C, 2.16 kg, and the optimized range is 10-15 g/10 min @ 190 C, 2.16 kg.

The hardness of 3D loop cushion is mainly from bending resistance of polymer fibers, when higher flexural modulus material is used, usually the more rigid 3D loop cushion material will be. Current flexural modulus of POE material suitable for 3D loop cushion is around 64 MPa, and recommended range for the application was ±5 MPa to reduce the impact on hardness. However, many additives used for flame resistance will significantly increase the flexural modulus of polymer compound. To control such hardness change for comfort reasons, the flexural modulus target of polymer compound was set<70 MPa. For the same reason, the Shore D hardness of polymer compound was set at 40±3 D.

Flame resistance performance is one of the key technical gaps for polyolefin 3D loop to be used in transportation industry, because it is a safety related property, especially for public transportation such as bus, the flame resistance provides the escaping time in the fire accident to save many lives. In the relative standards (such as China GB 8410), horizontal burning speed is required <100 mm/min. And some car OEMs proposed their own higher internal requirements to <70 mm/min, or even <20 mm/min. If the material can achieve self-distinguish during the burning test, the burning speed is recorded as 0, which is excellent performance on flame resistance. Target was set <20 mm/min, which can meet most of the auto OEMs' request on flame resistance.

Since the rebound test should use large 3D loop samples, and it needs a large amount of raw material and Dow vendor's machine to provide production service to make the sample, so we did not collect the rebound data for every flame resistance 3d loop formulation. Usually the less additive used, the rebound will be closer to neat POE 3D loop sample. So, it was reasonable to conclude that when flame retardant additives loading is lower than 6.7 wt %, comfort of the 3D loop products should be all acceptable.

### E. Measurement Information

Melt index of the polymer compounds was tested in Tinius Olsen MP600 in accordance with ASTM D1238. To meet the fiber extrusion requirement, melt index of polymer compound range 2-20 g/10 min.

Flexural modulus of the polymer compounds was measured in Instron 5566 in accordance with ASTM D790. The secant at 2% were used as the test result for flexural modulus. The flexural modulus directly influences the 3D loop fiber bending resistance, which is a key factor to influence the 3D loop cushion hardness. And usually with more fillers in the polymer formulation, the higher flexural modulus compounds will get. To control this hardness impact on POE 3D loop, flexural modulus target of the polymer compound was set at 64±5 MPa, so the acceptable flexural modulus was defined to be <70 MPa.

Hardness of the polymer compounds were measured in accordance with ASTM D2240, Shore D method was used on these samples. The more fillers used, the higher hardness of the polymer compound will get, our target for material hardness was 40=3 D.

The flame resistance tests were conducted in Shanghai Dow Center lab. The 3D loop article horizontal burning rate test was conducted on ATLAS horizontal burning machine, the 3D loop samples were cut into pieces with size 356×50×30 mm and the product original surface towards the flame, the burning rate was calculated from the below formula, and each sample used 5 specimens for calculation, the maximum burning rate from five specimens was taken to the test result.

$$V = 60 \times \frac{L}{T}$$

Where, V=burning rate, in mm/min; L=burnt distance, in mm; T=time taken to burn L, in seconds.

To achieve the premium flame resistance, target for horizontal burning speed of 3D loop was set <20 mm/min.

The inventive samples comprised a polyolefin content % in 3D loop material≥95% (total additives content≤5%) to keep suitable hardness of the cushion material. While the horizontal burning rate of 3D loop sample was still keeping <20 mm/min.

The illustrative examples show that the flame-resistant three-dimensional loop material according to the present disclosure can meet the auto seat flame resistance, and high rebound for seating comfort, for the high efficiency of flame retardant agent and good compatibility of additives to polyolefins. While the comparative flame-resistant 3D loop materials failed to find the balance on flame resistance, hardness and rebound performance.

Variations and modifications from the described embodiments exist. Finally, any number disclosed herein should be construed to mean approximate, regardless of whether the word “about” or “approximately” is used in describing the number. The appended claims intend to cover all those modifications and variations as falling within the scope of the invention.

What is claimed is:

1. A three-dimensional loop material comprising a polyolefin resin composition, wherein the composition comprises:
(a) from 95% to 98% by weight of the composition of at least one ethylene/alpha-olefin copolymer, and
(b) from 2% to 5% by weight of the composition of at least one flame retardant that is selected from halogenated flame retardants.

2. The three-dimensional loop material according to claim 1, wherein the at least one flame retardant comprises a brominated flame retardant.

3. The three-dimensional loop material according to claim 2, wherein the brominated flame retardant is selected from the group consisting of bis(2-hydroxyethyl)ether of tetrabromobisphenol A, bis(3-acryloyloxy-2-hydroxypropyl)ether of tetrabromobisphenol A, bis(3-methacryloyloxy-2-hydroxypropyl)ether of tetrabromobisphenol A, bis(3-hydroxypropyl)ether of tetrabromobisphenol A, bis(2,3-dibromopropyl)ether of tetrabromobisphenol A, diallyl ether of tetrabromobisphenol A, and bis(vinylbenzyl)ether of tetrabromobisphenol A; brominated polycarbonates, tetrabromobisphenol A polycarbonate oligomer, brominated polyacrylate such as polypentabromobenzyl acrylate; brominated polystyrenes, such as polydibromostyrenes and polytribromostyrenes; brominated BPA polyepoxides, tetrabromocyclooctanes; dibromoethyldibromocyclohexanes such as 1,2-dibromo-4-(1,2-dibromoethyl)-cyclohexane; ethylene-bis-tetrabromophthalimide; hexabromocyclododecanes; tetrabromophthalic anhydrides; brominated diphenylethers such as decabromodiphenyl ether; poly(2,6-dibromophenylene ether); tris(2,4,6-tribromophenoxy-1,3,5-triazine; tris(tribromoneopentyl)phosphate; decabromodiphenyl ethane; and any combination thereof.

4. The three-dimensional loop material according to claim 1, wherein the ethylene/alpha-olefin copolymer comprises from 60% to 90% by weight of the copolymer of ethylene.

5. The three-dimensional loop material according to claim 1, wherein the ethylene/alpha-olefin copolymer comprises from 10% to 40% by weight of the copolymer of a C₄₋₁₀ alpha-olefin.

6. The three-dimensional loop material according to claim 5, wherein the C₄₋₁₀ alpha-olefin comprises 1-octene.

7. The three-dimensional loop material according to claim 1, wherein the polyolefin resins comprised in the polyolefin resin composition have a melting index (MI) in a range of from 2 to 20 g/10 min.

8. The three-dimensional loop material according to claim 1, wherein the horizontal burning speed of the three-dimensional loop material is less than 20 mm/min.

9. The three-dimensional loop material according to claim 1, wherein the flexural modulus of the polymers comprised in the three-dimensional loop material is less than 70 MPa.

10. The three-dimensional loop material according to claim 1, wherein the three-dimensional loop material has a density that is within the range from about 30 kg/m³ to about 100 kg/m³.

11. The three-dimensional loop material according to claim 1, wherein the polyolefin resin composition further comprises from 0.3% to 3% by weight of the composition of a flame retardant synergist.

12. A method for producing the three-dimensional loop material according to claim 1, comprising the steps of:
(i) melting a polyolefin resin composition comprising:
(a) from 95% to 98% by weight of the composition of at least one ethylene/alpha-olefin copolymer, and
(b) from 2% to 5% by weight of the composition of at least one flame retardant;
(ii) discharging the molten polyolefin resin composition to a downward direction from a nozzle with a plurality of orifices to obtain loops of continuous fibers in a molten state;
(iii) allowing respective loops to come into contact with one another and to be heat-bonded whereby to form a random loop structure; and
(iv) cooling the structure to form the three-dimensional loop material.

13. A cushioning material comprising the three-dimensional loop material according to claim 1.

14. The cushioning material according to claim 13, wherein the cushioning material is for use in one or more selected from the group consisting of automobiles, motorcycles, trains, tractors, airplanes, boats, ships, spacecraft, hovercraft, bicycles, unicycles, tricycles, jet skis, ski lifts, roller coaster, glider, luge, bobsled, stadium seats, chairs, stools, beds, sofas, mattress, pillows, recliners, gurneys, and yoga mats.
